(19) United States
(12) Patent Application Publication
(10) Pub. No.: US 2023/0401811 A1
(43) Pub. Date: Dec. 14, 2023

(54) INFORMATION GENERATION APPARATUS, INFORMATION GENERATION METHOD, AND STORAGE MEDIUM

(71) Applicant: CANON KABUSHIKI KAISHA, Tokyo (JP)

(72) Inventors: SATOKO NAKAMAE, Kanagawa (JP); KOJI OKAWA, Tokyo (JP)

(21) Appl. No.: 18/327,677

(22) Filed: Jun. 1, 2023

(30) Foreign Application Priority Data
Jun. 13, 2022 (JP) 2022-095348

(51) Int. Cl. G06V 10/20; G06T 7/11; G06F 16/583

(52) U.S. Cl. CPC G06V 10/255; G06T 7/11; G06F 16/583

(57) ABSTRACT

An information generation apparatus includes an acquisition unit configured to acquire a captured image, and a generation unit configured to generate metadata on an object detected from the image, wherein the generation unit associates an object index for each of a plurality of segmented areas obtained by segmenting the image with a label index corresponding to integrated information obtained by integrating object detection results in each of the segmented areas in the metadata.

### BACKGROUND OF THE DISCLOSURE

### Field of the Disclosure

The present disclosure relates to an information generation technique.

### Description of the Related Art

A system for detecting an object in an image using video content analysis (VCA), generating metadata on information about the object, and delivering the metadata to a client apparatus has been in widespread use.

International Telecommunication Union-Telecommunication (ITU-T) H. 265 (November 2019) “High Efficiency Video Coding” discusses a technique for transmitting positional information about each object detected from an image as metadata to a client apparatus.

However, in Japanese Patent Application Laid-Open No. 2019-212963, information such as positional information about each object detected from an image is collectively stored in metadata and the metadata is transmitted to a client apparatus. This may cause an increase in the information amount of the metadata.

### SUMMARY OF THE DISCLOSURE

According to an aspect of the present disclosure, an information generation apparatus includes an acquisition unit configured to acquire a captured image, and a generation unit configured to generate metadata on an object detected from the image, wherein the generation unit associates an object index for each of a plurality of segmented areas obtained by segmenting the image with a label index corresponding to integrated information obtained by integrating object detection results in each of the segmented areas in the metadata.

Further features of the present disclosure will become apparent from the following description of exemplary embodiments with reference to the attached drawings.

### BRIEF DESCRIPTION OF THE DRAWINGS

FIG. 1 illustrates a configuration example of a system according to a first exemplary embodiment.

FIG. 2 is a block diagram illustrating functional blocks of an information generation apparatus.

FIG. 3, consisting of FIGS. 3A and 3B, illustrates a data structure of annotated regions supplemental enhancement information (ARSEI).

FIG. 4 is a flowchart illustrating a series of metadata generation processes.

FIG. 5 illustrates an example of image segmentation.

FIG. 6 is a table illustrating generated metadata.

FIG. 7 is a flowchart illustrating a series of metadata generation processes.

FIG. 8 is a block diagram illustrating a hardware configuration example of the information generation apparatus.

### DESCRIPTION OF THE EMBODIMENTS

Exemplary embodiments of the present disclosure will be described with reference to the accompanying drawings. Configurations described in the following exemplary embodiments are merely examples, and the present disclosure is not limited to the illustrated configurations.

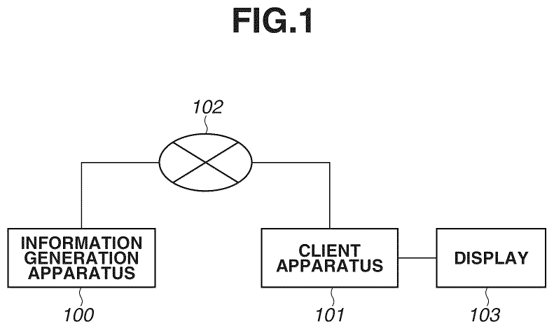

FIG. 1 illustrates a configuration example of a system according to a first exemplary embodiment. The system according to the first exemplary embodiment includes an information generation apparatus 100, a client apparatus 101, a display 103, and a network 102.

The information generation apparatus 100 and the client apparatus 101 are interconnected via the network 102. The network 102 is implemented by a plurality of routers, switches, cables, or the like compatible with communication standards such as Ethernet®.

The network 102 may be implemented by the Internet, a wired local area network (LAN), a wireless LAN, a wide area network (WAN), or the like.

The information generation apparatus 100 generates metadata including information about each object detected from an image. The information generation apparatus 100 transmits delivery data obtained by integrating encoded data obtained by encoding a captured image with metadata generated for the image to an external apparatus, such as the client apparatus 101, via the network 102. The information generation apparatus 100 may include functions of an image capturing apparatus. The information generation apparatus 100 may encode a captured image and may generate metadata based on the image and further generate delivery data by integrating the encoded data with the metadata. The information generation apparatus 100 may acquire an image from an image capturing apparatus (not illustrated) that captures an image, or a recording apparatus (not illustrated) that records an image. In this case, the information generation apparatus 100 may generate encoded data by encoding the acquired image and may generate metadata based on the image and further generate delivery data by integrating the encoded data with the metadata. The client apparatus 101 is, for example, an information processing apparatus such as a personal computer including a processor such as a central processing unit (CPU).

The display 103 includes a liquid crystal display (LCD) or the like, and displays, for example, a decoded image obtained by such a way that the encoded data included in the delivery data transmitted from the image capturing apparatus is decoded by the client apparatus 101. The display 103 is connected to the client apparatus 101 via a display cable compliant with communication standards such as a high-definition multimedia interface (HDMI®). The display 103 and the client apparatus 101 may be provided in a single housing.

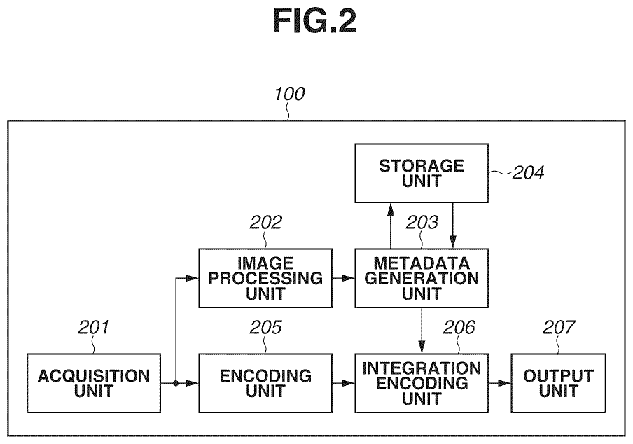

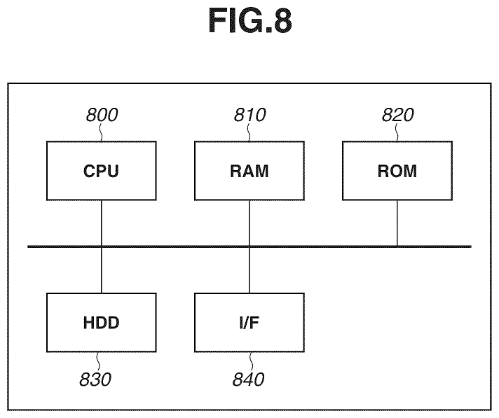

Processing to be performed by the information generation apparatus 100 according to the present exemplary embodiment will be described with reference to functional blocks illustrated in FIG. 2. FIG. 2 is a block diagram illustrating the functional blocks of the information generation apparatus 100 that executes metadata generation processing according to the present exemplary embodiment. For example, the functions illustrated in FIG. 2 are implemented as follows. That is, computer programs stored in a read-only memory (ROM) 820 to be described below with reference to FIG. 8 in the information generation apparatus 100 are executed by a CPU 800.

In the configuration illustrated in FIG. 2, an acquisition unit 201 acquires a captured image. In a case where the information generation apparatus 100 includes functions of an image capturing apparatus, the acquisition unit 201 may acquire an image captured by the information generation apparatus 100. The acquisition unit 201 may acquire an image from an image capturing apparatus or a recording apparatus via the network 102. The acquisition unit 201 sequentially acquires images of a series of frames forming a moving image one by one.

An image processing unit 202 detects each object included in the image acquired by the acquisition unit 201. As a method for detecting each object from an image, a known technique using a learning model or the like obtained by pattern matching or machine learning is used. In the present exemplary embodiment, a person is detected as an object. Objects other than a person, such as an animal, a vehicle, and a moving object, may also be detected.

A metadata generation unit 203 generates metadata for the image based on the result of object detection processing performed on the image by the image processing unit 202. The metadata generation unit 203 stores the generated metadata in a storage unit 204.

An encoding unit 205 encodes the image acquired by the acquisition unit 201 to generate encoded data, and outputs the encoded data. In the present exemplary embodiment, the encoding unit 205 encodes the image using H. 265 to generate encoded data, but instead may encode the image using other video coding standards such as H. 264 or H. 266. An integration encoding unit 206 integrates the metadata output from the metadata generation unit 203 with the encoded data output from the encoding unit 205, to thereby generate delivery data. An output unit 207 outputs the delivery data generated by the integration encoding unit 206 to an external apparatus, such as the client apparatus 101, via the network 102.

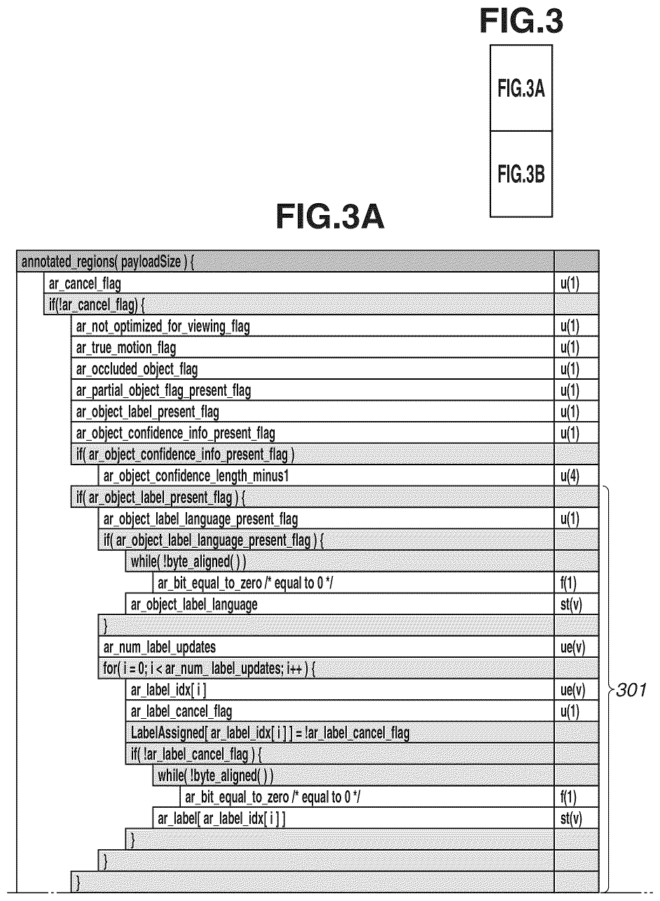

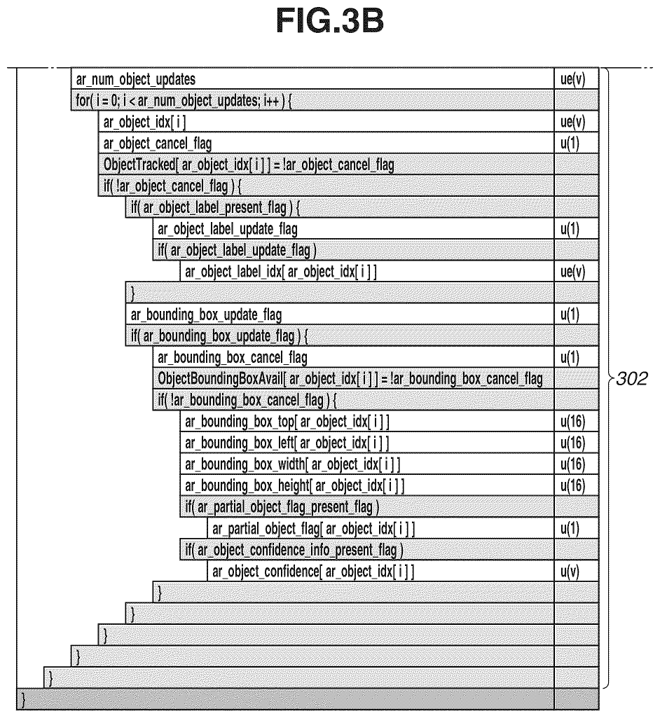

The metadata generated by the metadata generation unit 203 will be described in more detail with reference to FIG. 3. An annotated regions supplemental enhancement information (ARSEI) message in H. 265 is used as a metadata format. Metadata 300 illustrated in FIG. 3 is an example of metadata according to the present exemplary embodiment and has a data structure compliant with ARSEI. The metadata generation unit 203 stores values in various syntaxes within the data structure, thereby making it possible to generate metadata.

A data area 301 included in the metadata 300 illustrated in FIG. 3 is a part of the metadata 300 and is information described by setting ar_object_label_present_flag to “1”.

In the data area 301, the metadata generation unit 203 inserts the number of labels (ar_label) to be sent to the client apparatus 101 into ar_num_label_updates. Each label (ar_label) is a syntax with which predetermined information (information such as characters) of 255 bytes or less can be described. In the following description, assume a case where a label “personA” and a label “personB” are defined and a notification about the defined labels is to be provided to the client apparatus 101. In this case, ar_num_label_updates indicates “2”. The metadata generation unit 203 inserts a number of indices for identifying each label corresponding to the value indicated by ar_num_label_updates into ar_label_idx[i]. For example, the metadata generation unit 203 sets ar_label_idx[0]=0 and ar_label_idx[1]=1. The metadata generation unit 203 inserts a label to be associated with the index (ar_label_idx) of the label into ar_label[ar_label_idx[i]]. For example, the metadata generation unit 104 sets ar_label[ar_label_idx[0]]=“personA” and ar_label[ar_label_idx[1]]=“personB”. The generation of the metadata 300 including the data area 301 makes it possible to define the association between the label index (ar_label_idx) “0” and the label (first label) “personA” and the association between the label index (ar_label_idx) “1” and the label (second label) “personB”. The client apparatus 101 that has acquired the metadata 300 including the data area 301 can obtain information about the association between the label index (ar_label_idx) “0” and the label “personA” and information about the association between the label index (ar_label_idx) “1” and the label “personB”.

A data area 302 included in the metadata 300 illustrated in FIG. 3 is a part of the metadata 300 and is information described by setting a value in a range from “1” to “255” to ar_num_object_updates. In the data area 302, the label index corresponding to each object present in the image and positional information about the area in which the object is present can be described.

Specifically, the metadata generation unit 203 inserts the number of objects about which information on a certain image is updated for the client apparatus 101 into ar_num_object_updates. For example, assume a case where information about the position and label of each of a first object and a second object detected from the image is updated. In this case, the metadata generation unit 203 sets the value “2” as ar_num_object_updates. The metadata generation unit 104 inserts a number of indices for each object corresponding to the value indicated by ar_num_object_updates into ar_object_idx[i]. Assume that “0” is allocated as the object index for the first object and “1” is allocated as the object index for the second object. In this case, the metadata generation unit 203 sets ar_object_idx[0]=0 and ar_object_idx[1]=1 to be included in the data area 302.

The metadata generation unit 203 sets ar_object_label_update_flag to “1” by the number indicated by ar_num_object_updates (in other words, by the number corresponding to i=0 and the number corresponding to i=1 in the data area 302). The label index to be associated with the ar_object_idx[i] can be updated by setting ar_object_label_update_flag to “1”. After setting ar_object_label_update_flag to “1”, the metadata generation unit 203 selects the label index to be associated with each object present in the image from among the above-described label indices and inserts the selected label index into ar_object_label_idx[ar_object_idx[i]]. For example, assume a case where the label (ar_label) “personA” corresponding to label index “0” is to be associated with the first object corresponding to the object index “0”. In this case, the metadata generation unit 203 sets the label index (ar_label_idx) “0” corresponding to the label (ar_label) “personA” to ar_object_label_idx[ar_object_idx[0]]. Specifically, the metadata generation unit 104 sets ar_object_label_idx[ar_object_idx[0]]=0. This setting makes it possible to associate the object index “0” for the first object with the label index “0” corresponding to the label name “personA”.

The metadata generation unit 203 stores, as positional information about each object area, ar_bounding_box_top[ar_object_idx [i]], ar_bounding_box_left[ar_object_idx[i]], ar_bounding_box_width[ar_object_idx[i]], and ar_bounding_box_height[ar_object_idx[i]] in the metadata. The upper left coordinates of the object area are indicated by ar_bounding_box_top[ar_object_idx[i]] and ar_bounding_box_left[ar_object_idx[i]]. The width of the object area is indicated by ar_bounding_box_width[ar_object_idx[i]], and the height of the object area is indicated by ar_bounding_box_height[ar_object_idx[i]].

As described above, in the processing of updating information about each object using the above-described metadata 300, a label for each object that can be present in the image and positional information about the area in which each object is present in the image can be added. These pieces of information can be deleted using a predetermined flag. For example, ar_label_cancel_flag is set to “1” for a certain “i” in the data area 301, thereby making it possible to delete the corresponding information ar_label_idx[i]. The association between the object index and the label index using ar_object_label_idx[ar_object_idx[i]] can be deleted (cancelled) by setting ar_object_cancel_flag to “1” for a certain “i” in the data area 302. The positional information about the corresponding object area (ar_bounding_box_top[ar_object_idx[i]], ar_bounding_box_left[ar_object_idx[i]], ar_bounding_box_width[ar_object_idx[i]], and ar_bounding_box_height[ar_object_idx[i]]) can be deleted (cancelled) by setting ar_bounding_box_cancel_flag to “1” for a certain “i” in the data area 302.

The metadata generation unit 203 may set ar_num_object_updates to “0” to skip signaling of the information about the data area 302 to the metadata 300, and may set ar_object_label_present_flag to “1” to perform signaling of the information about the data area 301 to the metadata 300. For example, before delivering the delivery data on the image to the client apparatus 101, the metadata generation unit 203 may perform signaling of the information about the data area 301 to the metadata 300 in advance and deliver the information to the client apparatus 101.

According to the specifications of ARSEI, the maximum number of objects to be treated is “256”. In ARSEI, the coordinates of the upper left vertex of a bounding box representing an object are represented as 4-byte two-dimensional coordinates, and the width and height of the bounding box are each represented as 2-byte coordinates. Accordingly, positional information about the object is represented as 8-byte coordinates. If positional information about each of 256 objects in the image is updated by 30 FPS, the amount of information represented as 8 bytes×256 objects×30≈500 kbps is required only to update the positional information. If positional information (ar_bounding_box_top, ar_bounding_box_left) and size information (ar_bounding_box_width, ar_bounding_box_height) about all objects are updated for each image included in a moving image, the amount of information to be transmitted is increased, which may cause the compression of a network band. The amount of information varies depending on the number of detected objects, which makes it difficult to estimate the amount of data in advance.

The metadata generation unit 203 according to the present exemplary embodiment segments the image captured by the acquisition unit 201 into areas, and treats each segmented area as an object in ARSEI. The position, width, and height of each segmented area are transmitted as bounding box information in ARSEI. Further, ar_label_idx corresponding to integrated information obtained by integrating detection results in each area detected by the detection unit 203 is stored in the metadata. Examples of the integrated information about the detection results include the number of detected objects in each area. Thus, the reception side can obtain the integrated information about the detection results associated with each area. The positional information about each segmented area is not updated, thereby suppressing the amount of information to be transmitted by ARSEI. The number of objects corresponds to a fixed number of segmented areas. Accordingly, variations in the amount of information can be suppressed regardless of the number of objects detected by the detection unit 203.

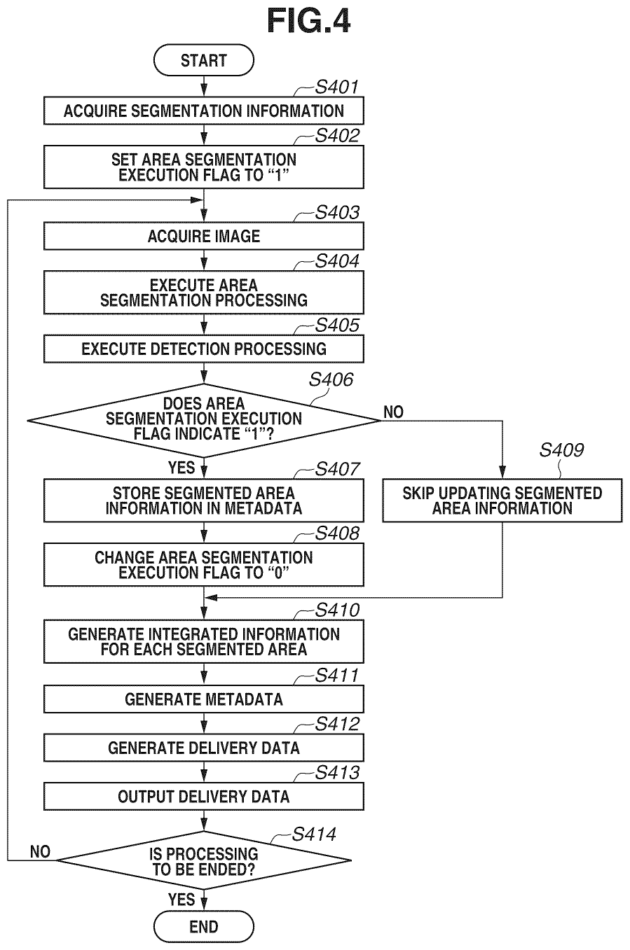

Metadata generation processing to be performed by the information generation apparatus 100 according to the present exemplary embodiment will be described with reference to FIGS. 4 to 6. Processing illustrated in FIG. 4 is executed to thereby make it possible to transmit integrated information about object detection results in each segmented area to the client apparatus 101. The processing in the flowchart illustrated in FIG. 4 is executed by the functional blocks illustrated in FIG. 2 that are implemented in such a way that, for example, the CPU 800 of the information generation apparatus 100 executes computer programs stored in the ROM 820 of the information generation apparatus 100.

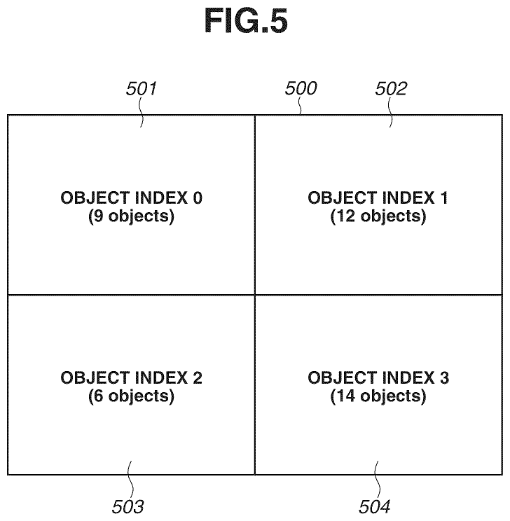

In step S401, the acquisition unit 201 acquires segmentation information about a plurality of segmented areas in an image. The segmentation information includes positional information about each of the plurality of segmented areas in the image and information about the number of segmented areas. For example, the segmentation information is preliminarily set by a user. Because of the properties of bounding boxes in ARSEI, a square area may be desirably set as each segmented area. In the present exemplary embodiment, as illustrated in FIG. 5, assume that an entire area 500 of the image is segmented into four segmented areas 501 to 504 and the image processing unit 202 acquires segmentation information including positional information about each of the segmented areas 501 to 504. The number of segmented areas is not limited to this example, as long as two or more segmented areas are obtained.

In step S402, the image processing unit 202 sets an area segmentation execution flag to “1”. Assume that an initial value for the area segmentation execution flag is “0”. In step S403, the acquisition unit 201 acquires one image included in a plurality of images included in a moving image as an image to be processed. In step S404, the image processing unit 202 executes area segmentation processing to segment the image to be currently processed into a plurality of segmented areas based on the segmentation information acquired in step S401. In the present exemplary embodiment, the image processing unit 202 executes area segmentation processing on the image to obtain the segmented areas 501 to 504 as illustrated in FIG. 5 based on the segmentation information. In step S404, the image processing unit 202 executes object detection processing on the image to be currently processed. The image processing unit 202 according to the present exemplary embodiment detects a person as an object to be detected. However, the object to be detected is not limited to a person. Objects other than a person, such as a moving object, a vehicle, and an animal, may be detected.

In step S406, the metadata generation unit 203 determines whether the area segmentation execution flag indicates “1”. In a case where it is determined that the area segmentation execution flag indicates “1” (YES in step S406), the processing proceeds to step S407. In a case where it is determined that the area segmentation execution flag indicates “0” (NO in step S406), the processing proceeds to step S409.

In step S407, the metadata generation unit 203 describes positional information about each segmented area in the data area 301 in the metadata 300. Specifically, the metadata generation unit 203 describes the positional information about each segmented area and the object index for each segmented area in association with the data area 302 of the metadata 300. For example, in the case illustrated in FIG. 5, the metadata generation unit 203 allocates the object index “0” to the segmented area 501, the object index “1” to the segmented area 502, the object index “2” to the segmented area 503, and the object index “3” to the segmented area 504. Because the number of objects to be updated is “4” in the data area 302, the metadata generation unit 203 sets ar_num_object_updates=4 and further sets ar_bounding_box_update_flag=1 for each segmented area (for each “i”=0 to 3). The metadata generation unit 203 stores ar_object_idx[0]=0 as the object index corresponding to the segmented area 501 and positional information about the segmented area 501 (coordinates of the upper left vertex and the width and height of the segmented area 501) in ar_bounding_box_top[ar_object_idx[0]], ar_bounding_box_left[ar_object_idx[0]], ar_bounding_box_width[ar_object_idx[0]], and ar_bounding_box_height[ar_object_idx[0]] in the data area 302. Similarly, the metadata generation unit 203 stores ar_object_idx[1]=1 as the object index corresponding to the segmented area 502 and positional information about the segmented area 502 (coordinates of the upper left vertex and the width and height of the segmented area 502) in ar_bounding_box_top[ar_object_idx[1]], ar_bounding_box_left[ar_object_idx[1]], ar_bounding_box_width[ar_object_idx[1]], and ar_bounding_box_height[ar_object_idx[1]] in the data area 302. Similarly, the metadata generation unit 203 stores ar_object_idx[2]=2 as the object index corresponding to the segmented area 503 and positional information about the segmented area 503 (coordinates of the upper left vertex and the width and height of the segmented area 503) in ar_bounding_box_top[ar_object_idx[2]], ar_bounding_box_left[ar_object_idx[2]], ar_bounding_box_width[ar_object_idx[2]], and ar_bounding_box_height[ar_object_idx[2]] in the data area 302. Similarly, the metadata generation unit 203 stores ar_object_idx[3]=3 as the object index corresponding to the segmented area 504 and positional information about the segmented area 504 (coordinates of the upper left vertex and the width and height of the segmented area 504) in ar_bounding_box_top[ar_object_idx[3]], ar_bounding_box_left[ar_object_idx[3]], ar_bounding_box_width[ar_object_idx[3]], and ar_bounding_box_height[ar_object_idx[3]] in the data area 302. In the manner as described above, the metadata generation unit 203 generates the metadata 300 described by associating, for each segmented area, the object index (ar_object_idx) for each segmented area with the positional information about each segmented area. After the processing of step S407 described above, the processing proceeds to step S408. In step S408, the metadata generation unit 203 changes the area segmentation execution flag from “1” to “0”. In the processing of the subsequent step, the processing proceeds to step S409 from step S406.

Referring again to the processing of step S406, in a case where it is determined that the area segmentation execution flag does not indicate “1”, or in a case where the area segmentation execution flag indicates “0” (NO in step S406), the processing proceeds to step S409. In step S409, the metadata generation unit 203 skips updating the information about each segmented area in the metadata. In other words, the metadata generation unit 203 sets ar_num_object_updates to “0” in the data area 301 to skip describing the information about each segmented area in the metadata.

In step S410, the metadata generation unit 203 generates integrated information obtained by integrating detection results for each segmented area in the image based on the result of detecting each object in the image to be currently processed. In the present exemplary embodiment, assume that integrated information about a certain segmented area is information about the number of objects detected in the certain segmented area. For example, a value indicating the number of objects detected from a certain segmented area is used as the integrated information about the certain segmented area. For example, as illustrated in FIG. 5, assume a case where nine persons are detected in the segmented area 501, 12 persons are detected in the segmented area 502, six persons are detected in the segmented area 503, and 14 persons are detected in the segmented area 504. In this case, integrated information about the segmented area 501 indicates “9”, integrated information about the segmented area 502 indicates “12”, integrated information about the segmented area 503 indicates “6”, and integrated information about the segmented area 504 indicates “14”.

In step S411, the metadata generation unit 203 executes metadata generation processing on the image to be currently processed. In step S411, the metadata generation unit 203 first defines the label including the integrated information and the label index.

In the example illustrated in FIG. 5, the metadata generation unit 203 sets the label (ar_label) to “9” for the integrated information associated with the label index (ar_label_idx) “0”. The metadata generation unit 203 sets ar_label_idx[0]=0 and ar_label[ar_label_idx[0]]=9 in the data area 301 of the metadata 300.

Similarly, the metadata generation unit 203 sets the label (ar_label) to “12” for the integrated information associated with the label index (ar_label_idx) “1”. The metadata generation unit 203 sets ar_label_idx[1]=1 and ar_label[ar_label_idx[1]]=12 in the data area 301 of the metadata 300.

Similarly, the metadata generation unit 203 sets the label (ar_label) to “6” for the integrated information associated with the label index (ar_label_idx) “2”. The metadata generation unit 203 sets ar_label_idx[2]=2 and ar_label[ar_label_idx[2]]=6 in the data area 301 of the metadata 300.

Similarly, the metadata generation unit 203 sets the label (ar_label) to “14” for the integrated information associated with the label index (ar_label_idx) “3”. The metadata generation unit 203 sets ar_label_idx[3]=3 and ar_label[ar_label_idx[3]]=14 in the data area 301 of the metadata 300.

In step S411, the metadata generation unit 203 associates the label index with the object index in the data area 302 of the metadata 300.

Specifically, the metadata generation unit 203 sets ar_object_label_idx[ar_object_idx[0]]=0 in the data area 302 to associate the object index (ar_object_idx[0]) “0” for the segmented area 501 with the label index (ar_label_idx) “0” corresponding to the number of objects “9” in the segmented area 501. This makes it possible to associate the information about ar_object_idx[0] (object index=0) with the information about ar_label_idx “0”. In a case where the client apparatus 101 has received the information, the client apparatus 101 can determine that the number of persons detected from the segmented area 501 corresponding to the object index “0” corresponds to the label “9” corresponding to the label index “0” associated with the object index “0”.

Similarly, the metadata generation unit 203 sets ar_object_label_idx[ar_object_idx[1]]=1 in the data area 302 to associate the object index (ar_object_idx[1]) “1” for the segmented area 502 with the label index (ar_label_idx) “1” corresponding to the number of objects “12” in the segmented area 502.

Similarly, the metadata generation unit 203 sets ar_object_label_idx[ar_object_idx[2]]=2 in the data area 302 to associate the object index (ar_object_idx[2]) “2” for the segmented area 503 with the label index (ar_label_idx) “2” corresponding to the number of objects “6” in the segmented area 503.

Similarly, the metadata generation unit 203 sets ar_object_label_idx[ar_object_idx[3]]=3 in the data area 302 to associate the object index (ar_object_idx[3]) “3” for the segmented area 503 with the label index (ar_label_idx) “3” corresponding to the number of objects “14” in the segmented area 504.

In the manner as described above, the metadata generation unit 203 generates metadata by associating the label index with the object index in the data area 302 of the metadata 300.

In step S412, the integration encoding unit 206 generates delivery data including the encoded data on the image acquired by the acquisition unit 401 and the metadata generated in step S411. In step S413, the output unit 207 outputs the delivery data generated in step S412 to the client apparatus 101.

In step S414, the metadata generation unit 203 determines whether the processing in the flowchart illustrated in FIG. 4 is to be ended. In a case where it is determined that the processing is to be ended (YES in step S414), the processing in the flowchart illustrated in FIG. 4 is ended. On the other hand, in a case where the processing is not to be ended (NO in step S414), the processing returns to step S403. In step S403, the acquisition unit 201 acquires the image to be processed. In the subsequent processing, a label index defined in advance may be used. Specifically, for example, assume a case where the number of objects detected in the segmented area 504 in an image acquired as a new processing target is “9”. In this case, the association between the label index (ar_label_idx) “0” and the label (ar_label) “9” is already defined as described above. Accordingly, the metadata generation unit 203 sets ar_object_label_idx[ar_object_idx[3]]=0 in the data area 302 to associate the object index (ar_object_idx[3]) “3” for the segmented area 504 with the label index (ar_label_idx) “0” corresponding to the number of objects “9” in the segmented area 504. Thus, the label index defined in advance may be used.

While the number of objects detected in a certain segmented area is used as integrated information about the certain segmented area in the processing described above with reference to FIG. 4, the integrated information is not limited to the number of detected objects. For example, information about a range of the number of objects to which the number of objects detected in a certain segmented area belongs may be used as the integrated information.

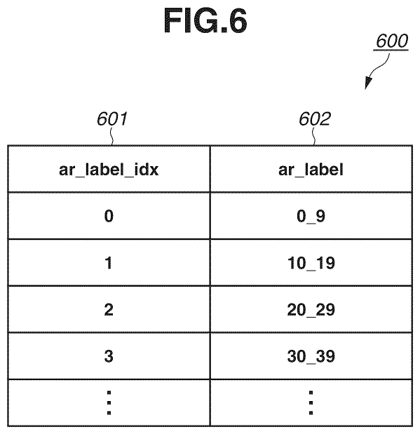

An example in this case will be described below. As illustrated in FIG. 6, the metadata generation unit 203 associates ar_label_idx 601 with ar_label 602 indicating the range of the number of objects in the data area 301. Specifically, the metadata generation unit 203 sets ar_label_idx[0]=0 and ar_label[ar_label_idx[0]]=0_9. This setting makes it possible to define the association between the label index (ar_label_idx) “0” and the label (ar_label) “0_9” indicating the range of the number of objects “0” to “9”, and to provide a notification about the association to the client apparatus 101.

Similarly, the metadata generation unit 203 sets ar_label_idx[1]=1 and ar_label[ar_label_idx[1]]=10_19. This setting makes it possible to define the association between the label index (ar_label_idx) “1” and the label (ar_label) “10_19” indicating the range of the number of objects from “10” to “19”, and to provide a notification about the association to the client apparatus 101.

Similarly, the metadata generation unit 203 sets ar_label_idx[2]=2 and ar_label[ar_label_idx[2]]=20_29. This setting makes it possible to define the association between the label index (ar_label_idx) “2” and the label (ar_label) “20_29” indicating the range of the number of objects “20” to “29”, and to provide a notification about the association to the client apparatus 101.

Similarly, the metadata generation unit 203 sets ar_label_idx[3]=3 and ar_label[ar_label_idx[3]]=30_39. This setting makes it possible to define the association between the label index (ar_label_idx) “3” and the label (ar_label) “30_39” indicating the range of the number of objects “30” to “39”, and to provide a notification about the association to the client apparatus 101.

In the manner as described above, information about the association between the label index (ar_label_idx) and the label (ar_label) indicating information about the range of the number of objects as illustrated in FIG. 6 can be sent to the client apparatus 101.

The metadata generation unit 203 identifies the ar_label 602 in which the range of the number of objects to which the number of objects detected in a certain segmented area belongs is described. The metadata generation unit 203 associates the ar_label_idx 601 associated with the identified ar_label 602 with the object index for the certain segmented area in the data area 302.

For example, as illustrated in FIG. 5, assume a case where nine persons are detected as objects in the segmented area 501, 12 persons are detected as objects in the segmented area 502, six persons are detected as objects in the segmented area 503, and 14 persons are detected as objects in the segmented area 504. In this case, nine persons are detected as objects in the segmented area 501, and thus the number of objects in the segmented area 501 belongs to the range of “0” to “9”. Accordingly, the metadata generation unit 203 identifies ar_label 602 “0_9” and also identifies the corresponding ar_label_idx “0”. The metadata generation unit 203 sets ar_object_label_idx[ar_object_idx[0]]=0 to associate the object index (ar_object_idx[0]) “0” for the segmented area 501 with the label index (ar_label_idx) “0” corresponding to the range of the number of objects “0” to “9”.

Similarly, since the number of objects in the segmented area 502 is “12, the metadata generation unit 203 sets ar_object_label_idx[ar_object_idx[1]]=1 to associate the object index (ar_object_idx[1]) “1” for the segmented area 502 with the label index (ar_label_idx) “1” corresponding to the range of the number of objects “10” to “19”.

Similarly, since the number of objects in the segmented area 503 is “6”, the metadata generation unit 203 sets ar_object_label_idx[ar_object_idx[2]]=0 to associate the object index (ar_object_idx[2]) “2” for the segmented area 503 with the label index (ar_label_idx) “0” corresponding to the range of the number of objects “0” to “9”.

Similarly, since the number of objects in the segmented area 504 is “14”, the metadata generation unit 203 sets ar_object_label_idx[ar_object_idx[3]]=1 to associate the object index (ar_object_idx[3]) “3” for the segmented area 504 with the label index (ar_label_idx) “1” corresponding to the range of the number of objects “10” to “19”.

As described above, in a case where the number of objects detected in a first segmented area belongs to a first range, the metadata generation unit 203 associates a first label index corresponding to the first range with an object index for the first segmented area in metadata. Similarly, in a case where the number of objects detected in a second segmented area different from the first segmented area belongs to a second range different from the first range, the metadata generation unit 203 associates the label index corresponding to the second range with an object index for the second segmented area in the metadata.

As described above, the information generation apparatus 100 according to the present exemplary embodiment executes the following processing instead of transmitting positional information about each object detected from an image as metadata. That is, the information generation apparatus 100 transmits, for each segmented area obtained by segmenting the image, metadata obtained by associating the label index corresponding to integrated information obtained by integrating detection results in each segmented area with the object index for each segmented area. With this configuration, an increase in the information amount of the metadata can be suppressed compared to a case where positional information about each object detected from an image is transmitted as metadata.

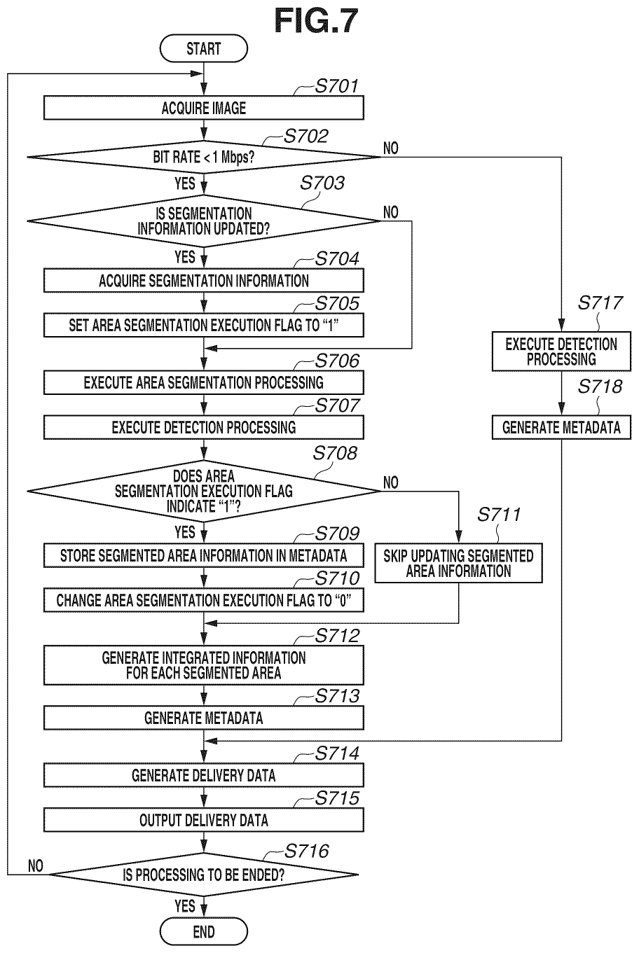

The information generation apparatus 100 according to a second exemplary embodiment determines whether to transmit integrated information for each segmented area by performing area segmentation processing based on delivery settings made in advance. With this configuration, information about each object can be transmitted by ARSEI in a case where the bandwidth is not compressed even when the bandwidth is wide and the information amount of the metadata is increased, and integrated information can be transmitted under a low-bit-rate environment in which the bandwidth is likely to be compressed, thereby suppressing the information amount of the metadata. Processing to be performed by the information generation apparatus 100 according to the second exemplary embodiment will be described with reference to FIG. 7. Differences between the first exemplary embodiment and the second exemplary embodiment will be mainly described, and redundant descriptions of the components and processing that are identical or equivalent to those of the first exemplary embodiment are omitted.

In step S701, the acquisition unit 201 acquires an image to be processed. In step S702, the image processing unit 202 determines whether a bit rate set as a delivery setting is less than a threshold with reference to the delivery settings made in advance. For example, in a case where it is determined that the bit rate is less than 1 Mbps (YES in step S702), there is a possibility that the bandwidth can be compressed by metadata. Then, the processing proceeds to step S703. On the other hand, in a case where it is determined that the bit rate is more than or equal to 1 Mbps (NO in step S702), it is determined that the bandwidth is sufficiently wide. Then, the processing proceeds to step S717.

In step S703, the image processing unit 202 determines whether segmentation information is updated. In a case where the image processing unit 202 determines that the segmentation information is updated (YES in step S703), the processing proceeds to step S704. In a case where the image processing unit 202 determines that the segmentation information is not updated (NO in step S703), the processing proceeds to step S706. For example, in a case where a user operation is performed to change the number of segmented areas and positional information about each segmented area during image segmentation processing, it is determined that the segmentation information is updated in step S703. In the case of first executing the processing of step S703 after the processing illustrated in FIG. 7 is started, it is determined that the segmentation information is updated, and then the processing proceeds to step S704 from step S703.

In step S704, the acquisition unit 201 acquires the latest segmentation information currently set. In step S705, the image processing unit 202 sets the area segmentation execution flag to “1”. Assume that an initial value for the area segmentation execution flag is “0”. In step S706, the image processing unit 202 executes area segmentation processing to segment the image to be currently processed into a plurality of segmented areas based on the segmentation information acquired in step S704. The image processing unit 202 executes area segmentation processing on the image to obtain, for example, the segmented areas 501 to 504 as illustrated in FIG. 5 based on the segmentation information.

Steps S707 to S716 are similar to steps S405 to S414, respectively, and thus descriptions thereof are omitted. Referring again to the processing of step S702, in a case where it is determined that the bit rate is more than or equal to 1 Mbps (NO in step S702), the processing proceeds to step S717. In step S717, the image processing unit 202 executes object detection processing on the image to be currently processed. In step S718, the metadata generation unit 203 stores the positional information about each object detected from the image in step S717 in the metadata 300, and then the processing proceeds to step S714. In this case, in step S714, the integration encoding unit 206 generates delivery data by integrating the metadata generated in step S718 with encoded data obtained by encoding the image.

As described above, the information generation apparatus 100 according to the present exemplary embodiment determines whether to transmit integrated information for each segmented area based on delivery settings. With this configuration, in a case where the bandwidth is sufficiently wide, detailed information about each object can be transmitted, and in a case where the bandwidth is tight, integrated information can be transmitted, thereby suppressing an increase in the amount of information.

A hardware configuration example of the information generation apparatus 100 to implement the functions according to the exemplary embodiments will be described with reference to FIG. 8. While a hardware configuration example of the information generation apparatus 100 is to be described below, the information generation apparatus 100 may also be implemented by a similar hardware configuration.

The information generation apparatus 100 according to the present exemplary embodiment includes the CPU 800, a random access memory (RAM) 810, the ROM 820, a hard disk drive (HDD) 830, and an interface (I/F) 840.

The CPU 800 is a central processing unit that controls the operation of the information generation apparatus 100 in an integrated manner. The RAM 810 temporarily stores computer programs to be executed by the CPU 800. The RAM 810 provides a work area to be used for the CPU 800 to execute processing. The RAM 810 may function as, for example, a frame memory or a buffer memory.

The ROM 820 stores programs and the like to be used for the CPU 800 to control the information generation apparatus 100. The HDD 830 is a storage device that records image data and the like.

The IF 840 establishes communication with an external apparatus via the network 102 based on Transmission Control Protocol (TCP)/Internet Protocol (IP), Hypertext Transfer Protocol (HTTP), or the like.

While the above-described exemplary embodiments illustrate an example where the CPU 800 executes processing, at least a part of the processing of the CPU 800 may be performed by a dedicated hardware module. For example, processing of reading out a program code from the ROM 820 and loading the program code into the RAM 810 may be executed by a direct memory access (DMA) functioning as a transfer device.

The present disclosure can also be implemented by processing in which a program for implementing one or more functions according to the exemplary embodiments described above is read out by one or more processors. The program may be supplied to a system or an apparatus including a processor via a network or a storage medium.

The present disclosure can also be implemented by a circuit (e.g., an application-specific integrated circuit (ASIC)) for implementing one or more functions according to the above-described exemplary embodiments. Each unit of the information generation apparatus 100 may be implemented by hardware illustrated in FIG. 8, or may be implemented by software.

While the exemplary embodiments of the present disclosure are described above, the above-described exemplary embodiments are merely specific examples for carrying out the present disclosure. The technical scope of the present disclosure should not be interpreted in a limited manner by the exemplary embodiments. That is, the present disclosure can be carried out in various forms without departing from the technical idea and the main features thereof. For example, any combination of the exemplary embodiments is also included in the disclosed contents of the present disclosure.

According to an exemplary embodiment of the present disclosure, it is possible to suppress an increase in the information amount of metadata associated with information about each object detected from an image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-095348, filed Jun. 13, 2022, which is hereby incorporated by reference herein in its entirety.

What is claimed is:

1. An information generation apparatus comprising:
an acquisition unit configured to acquire a captured image; and
a generation unit configured to generate metadata on an object detected from the image,
wherein the generation unit associates an object index for each of a plurality of segmented areas obtained by segmenting the image with a label index corresponding to integrated information obtained by integrating object detection results in each of the segmented areas in the metadata.

2. The information generation apparatus according to claim 1, wherein the metadata generated by the generation unit is metadata compliant with annotated regions supplemental enhancement information (ARSEI).

3. The information generation apparatus according to claim 1, further comprising a detection unit configured to detect an object from the image.

4. The information generation apparatus according to claim 1, wherein the generation unit allocates the object index to each of the plurality of segmented areas, and stores the object index for each of the plurality of segmented areas in the metadata.

5. The information generation apparatus according to claim 1, wherein the integrated information about the plurality of segmented areas indicates a number of objects detected in each of the segmented areas.

6. The information generation apparatus according to claim 1,
wherein in a case where the number of objects detected in a first segmented area included in the plurality of segmented areas belongs to a first range, the generation unit associates a first label index corresponding to the first range with an object index for the first segmented area in the metadata, and
wherein in a case where the number of objects detected in a second segmented area included in the plurality of segmented areas and different from the first segmented area belongs to a second range different from the first range, the generation unit associates a label index corresponding to the second range with an object index for the second segmented area in the metadata.

7. The information generation apparatus according to claim 1,
wherein the acquisition unit further acquires information about a set bit rate, and
wherein in a case where the bit rate is less than a predetermined threshold, the generation unit associates, for each of the plurality of segmented areas obtained by segmenting the image, the object index for each of the plurality of segmented areas with the label index corresponding to the integrated information obtained by integrating object detection results in each of the segmented areas in the metadata.

8. An information generation method comprising:
acquiring a captured image; and
generating metadata on an object detected from the image,
wherein in the generating, an object index for each of a plurality of segmented areas obtained by segmenting the image is associated with a label index corresponding to integrated information obtained by integrating object detection results in each of the segmented areas in the metadata.

9. A non-transitory computer-readable storage medium storing a computer program for causing a computer to execute an information generation method comprising:
acquiring a captured image; and
generating metadata on an object detected from the image,
wherein in the generating, an object index for each of a plurality of segmented areas obtained by segmenting the image is associated with a label index corresponding to integrated information obtained by integrating object detection results in each of the segmented areas in the metadata.
